(19) United States
(12) Patent Application Publication
(10) Pub. No.: US 2013/0199365 A1
(43) Pub. Date: Aug. 8, 2013

(54) Annular Seal Element

(71) Applicants: Oliver Gaertner, Abstatt (DE); Wolfgang Schuller, Cleebronn (DE); Michael Schuessler, Seckach (DE)

(72) Inventors: Oliver Gaertner, Abstatt (DE); Wolfgang Schuller, Cleebronn (DE); Michael Schuessler, Seckach (DE)

(73) Assignee: Robert Bosch GmbH, Stuttgart (DE)

(21) Appl. No.: 13/639,547

(22) PCT Filed: Feb. 9, 2011
(86) PCT No.: PCT/EP11/51847

§ 371 Date: Mar. 15, 2013

(30) Foreign Application Priority Data
Apr. 7, 2010 (DE) 10 2010 003 674.9

(51) Int. Cl. F16J 15/32

(52) U.S. Cl. CPC F16J 15/32
USPC 92/168

(57) ABSTRACT

An annular seal element is configured to seal off a pressurized region filled with a fluid. The annular seal element has one end face which is pressed onto a contact surface of a piston. The end face is formed with a sealing contour in such a way that the sealing contour is elastically deformable on the contact surface by the pressure exerted.

### STATE OF THE ART

The invention relates to an annular seal element, in particular for a hydraulic piston pump, for sealing off a pressurized region filled with a fluid, in which one end face is pressed against a contact surface of a piston. The invention further relates to a hydraulic piston pump having an annular seal element and to a vehicle braking system having a hydraulic piston pump.

Annular seal elements for sealing off a pressurized region of hydraulic piston pumps usually bear axially against a piston and as the piston in a cylinder runs in and out they slide past an interior circumferential surface of the cylinder, on a so-called sealing face. The seal element is generally positioned between the cylinder and the piston in such a way that it is pressed with its end face against a contact surface of the piston. This end face of the seal element is a substantially plane surface.

DE 102 40 052 A1 discloses a seal and guide device, in particular for a cylindrical pump element. This device comprises a seal element composed of an elastic material and a guide element composed of a substantially inelastic material, the seal element being firmly connected, positively and/or non-positively, to the guide element, so that the seal element and the guide element are formed as a common sub-assembly. The seal element comprises a lip arrangement, which is arranged at a predefined angle to the circumference of a surface of a moving piston element that is to be sealed. The seal element is thereby capable of sealing off the piston element both in the unpressurized and in the pressurized state, since by virtue of its elasticity it always presents forces in a perpendicular direction to the outer circumference of the piston element.

In order to generate large sealing forces between the seal element and the piston element, the seal element preferably comprises an area, which in the pressurized state of the seal element presents an additional force to the lip arrangement, in order to press the seal element against the piston element. This is intended further to improve the security of the seal.

The object of the invention is to provide a seal element which affords a good seal, particularly between the end face of the seal element and the corresponding contact surface of the piston. The seal element should furthermore compensate for geometrical inaccuracies of the contact surface of the piston and therefore afford an accurate fit.

### DISCLOSURE OF THE INVENTION

According to the invention an annular seal element is created, in particular for a hydraulic piston pump, for sealing off a pressurized region filled with a fluid, in which one end face is pressed against a contact surface of a piston, and in which the end face is formed with a sealing contour, in such a way that the sealing contour can be elastically deformed against the contact surface by the pressure exerted.

The hydraulic piston pump comprises a cylindrical piston, which is supported so that it can run in and out in an interior space of a cylinder. The interior space of the cylinder is defined by a cylindrical wall. An annular seal element according to the invention, which seals off a pressurized region filled with a fluid in the interior space of the cylinder, is arranged between the cylindrical wall and the piston. As the piston runs out of the cylinder, a vacuum is built up in the pressurized region and the piston draws fluid into the pressurized region via an inlet valve. As it runs in, the piston displaces the fluid from the pressurized region via an outlet valve into a hydraulic system for performing work.

A fluid is here taken to mean a gas or also a hydraulic fluid, such as a mineral oil of glycol-based hydraulic fluid.

The annular seal element according to the invention comprises an inner circumferential surface and an outer circumferential surface, and an end face. The inner circumferential surface of the seal element bears against an outer circumferential surface of the piston and the outer circumferential surface of the seal element bears against the inner circumferential surface of the cylinder, against the so-called sealing surface. As the piston runs into and out of the cylinder, the sealing surface and the outer circumferential surface of the sealing ring move relative to one anther.

The end face of the seal element is pressed and therefore held in position against a contact surface—a step of the piston—by means of a return spring, for example, which is supported inside the pressurized region.

According to the invention the end face is provided with a specific sealing contour, which has elastic characteristics. Owing to the pressure applied, this sealing contour is elastically deformed against the contact surface of the piston. The sealing contour attaches itself with a precise fit to a specific surface structure of the contact surface and seals this off so that it is substantially fluid-tight. Due to the deformation of the sealing contour, the end face conforms better to the contact surface than an end face having a substantially plane surface. The leak-tightness of the seal element is advantageously increased. In this way it is possible, in particular, to compensate for irregularities of the contact surface of the piston resulting from the production process. Leakages of the hydraulic piston pump are reduced, particularly in the case of slight backpressures, and the efficiency of the pump is therefore increased.

According to a first advantageous development of the annular seal element the sealing contour comprises at least one sealing lip.

In such a development the sealing lip in cross section may taper to a point or it may also have a domed shape. The sealing lip is elastically deformable and under pressure attaches itself to the contact surface. In particular, because of its great flexibility, a relatively narrow sealing lip conforms very closely to irregularities in the contact surface, such as indentations or elevations.

According to a second advantageous development of the annular seal element the sealing contour comprises a plurality of sealing lips which in cross section are of corrugated design.

A sealing contour having a plurality of sealing lips affords a particularly effective seal. This proves advantageous when high pressure prevail in the pressurized region of the piston pump. The sealing contour may be designed as a so-called ribbed sheet, for example, preferably having 10 to 15 individual sealing lips. The individual sealing lips are elastically deformed when pressure is built up on the end face of the seal element, so that the individual sealing lips conform optimally to the surface structure of the contact surface.

Furthermore, the sealing lips—viewed in cross section—may also be elastically deformed by pressure applied laterally. This lateral pressure occurs when high pressures prevail in the pressurized region and fluid is forced into a region between the end face of the seal element and the contact surface of the piston. In such a case the fluid presses the sealing lips in the direction of the outer circumferential surface of the seal element and the sealing lips attach themselves tightly to the contact surface and prevent a leakage of the fluid in the direction of the cylinder wall.

Sealing lips having a corrugated shape in cross section conform especially well to a contact surface having slight irregularities.

According to a third advantageous development of the annular seal element the sealing contour comprises a plurality of sealing lips which in cross section taper to a point.

This sealing contour having a plurality of sealing lips also provides a particularly effective seal. The sealing contour may likewise be embodied as a so-called ribbed sheet preferably having 10 to 15 individual sealing lips. The individual sealing lips are elastically deformed when pressure is built up on the end face of the seal element, so that the individual sealing lips conform optimally to the surface structure of the contact surface. Sealing lips, which in cross section taper to a point, are particularly suitable in the case of contact surfaces which have more pronounced irregularities in the surface structure. The sealing lips with their tips are capable of conforming well to depressions or grooves, for example, and of sealing these effectively.

According to a fourth advantageous development of the annular seal element, in plan view the sealing contour is of helical design.

Such a helical sealing contour is formed from a helically arranged sealing lip, which in cross section may be of domed design or one tapering to a point. The sealing contour preferably comprises 8 to 15 turns. The helical shape affords good sealing over a large area. The tips or domes of the sealing contour are easily deformed elastically under pressure and attach themselves well to the contact surface of the piston.

Even under slight deformation, irregularities or defects in the contact surface are better compensated for than by an end face having a continuous, substantially plane surface.

According to a fifth advantageous development of the annular seal element at least one, in particular two, high pressure-side sealing lips are integrally formed onto the seal element on the side remote from the end face.

The high pressure-side sealing lip is arranged on the opposite side to the end face. The sealing lip has two limbs, which each form a defined angle, firstly with the sealing surface, that is to say with the inner circumferential surface of the cylinder, and secondly with the outer circumferential surface of the piston. The high pressure-side sealing lip terminates tightly against the sealing surface of the cylinder and the outer circumferential surface of the piston. In its contour the high pressure-side sealing lip may be designed in such a way that a part of a valve housing is accommodated, so that the valve housing supports the seal element on the outer circumferential surface of the piston.

According to a sixth advantageous development of the annular seal element the seal element is a plastic injection-molded part. Such a seal element is integrally formed, preferably from an elastomer or elastomer-like material. It is inexpensive to manufacture and in the manufacturing process is easy to join together with other components.

According to a seventh advantageous development of the annular seal element the seal element is integrally formed onto a valve housing.

In such a case the seal element forms a single component with the valve housing. This element is preferably inexpensively manufactured from plastic in an injection molding process and can easily be inserted into the hydraulic piston pump.

In addition, a hydraulic piston pump having an annular seal element is created.

The piston pump according to the invention comprises a cylinder and a piston capable of running in and out in the cylinder. An annular seal element according to the invention is arranged between the piston and an inner circumferential surface, the so-called sealing surface, and seals off a fluid-filled pressurized region inside the cylinder according to the features discussed above.

Furthermore, a vehicle braking system having a hydraulic piston pump is created.

Such a vehicle braking system may be an antilock braking system (ABS), for example, a traction control system (TCS), an electronic stability program (ESP) or also an electro-hydraulic braking system (EHB). In such systems it is particularly advantageous if the hydraulic piston pumps have a low leakage or good leak-tightness, in order to afford optimum functioning of the braking system in prolonged operating service. Furthermore, vehicle braking systems must not have a high leakage rate, so that they do not adversely affect the working of adjacent components.

### BRIEF DESCRIPTION OF THE DRAWINGS

Exemplary embodiments of the solution according to the invention are explained in more detail below with reference to the drawings attached, in which:

FIG. 1 shows a longitudinal section of a hydraulic piston pump with a first exemplary embodiment of a seal element according to the invention,

FIG. 2 shows a perspective view of the detail II in FIG. 1 to a larger scale,

FIG. 3 shows a perspective view of a second exemplary embodiment of a seal element according to the invention, which is integrally formed on a valve cage,

FIG. 4 shows the cross section IV-IV in FIG. 3,

FIG. 5 shows a cross section of a third exemplary embodiment of a seal element according to the invention.

### DESCRIPTION OF EMBODIMENTS

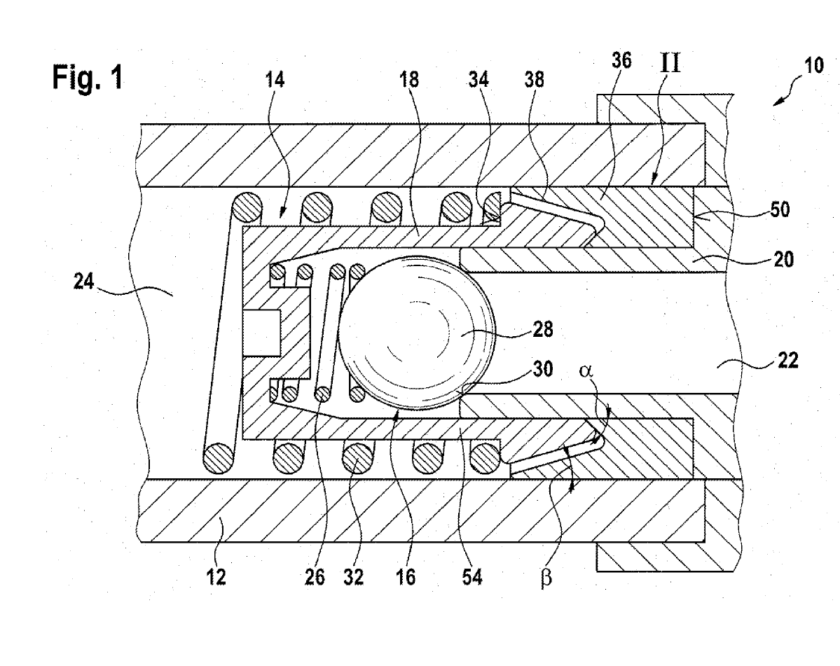

FIG. 1 illustrates a detail of a hydraulic piston pump 10 having a cylinder 12 and a piston 14 capable of running in and out in the cylinder 12.

The piston 14 comprises an inlet valve 16. The inlet valve 16 is arranged in a valve housing 18, which is clamped on a mount 20. The valve 16 is intended, by means of a reciprocating movement of the piston 14, to draw fluid through an inlet device 22 into a pressurized region 24 inside the cylinder 12 and to deliver it under pressure through an outlet (not shown) having an outlet valve from the pressurized region 24 into a hydraulic system for performing work. The fluid in this case is a brake fluid.

The valve housing 18 is designed as a cupped cage, inside which is a helical return spring 26, which presses against a spherical closing body 28. The closing body 28 thereby bears against a valve seat 30, which is formed on the end face of the piston 14.

The piston 14 is spring loaded in an axial direction by means of a return spring 32 arranged in the pressurized region 24. With reference to FIG. 1, the return spring 32 is supported at its left end on an end face of the cylinder 12 and at its right end presses against a spring seat 34, which is formed as a part of the valve housing 18. The spring seat 34 is therefore fixedly coupled to the piston 14, so that the return spring 32 correspondingly presses against the piston 14 via the spring seat 34.

When the piston 14 in FIG. 1 is pushed to the right out of the cylinder 12 by means of the return spring 32, the closing body 28 of the inlet valve 16 is lifted off from the valve seat 30 against the force of the helical return spring 26, since a vacuum is built up in the cylinder 12. In this movement of the piston 14 the inlet valve 16 is opened and fluid is drawn into the pressurized region 24 via the inlet device 22.

When the piston 14 in FIG. 1 is pushed to the left in the cylinder 12 by means of an eccentric (not shown), the inlet valve 16 closes, the outlet valve (not shown) is opened and the fluid is delivered from the pressurized region 24 into a hydraulic system for performing work.

An annular seal element 36 according to the invention, composed of an elastomer material, which serves to seal off the pressurized region 24 in the cylinder 12, is arranged between the piston 14 and the cylinder 12. The seal element 36 is pressed onto the piston 14 and bears axially against the outer circumferential surface of the piston 14. The seal element 36 is fixedly held against this outer circumferential surface by means of the valve housing 18 clamped onto the mount 20, in that the valve housing 18 engages in the seal element 36 both positively and non-positively.

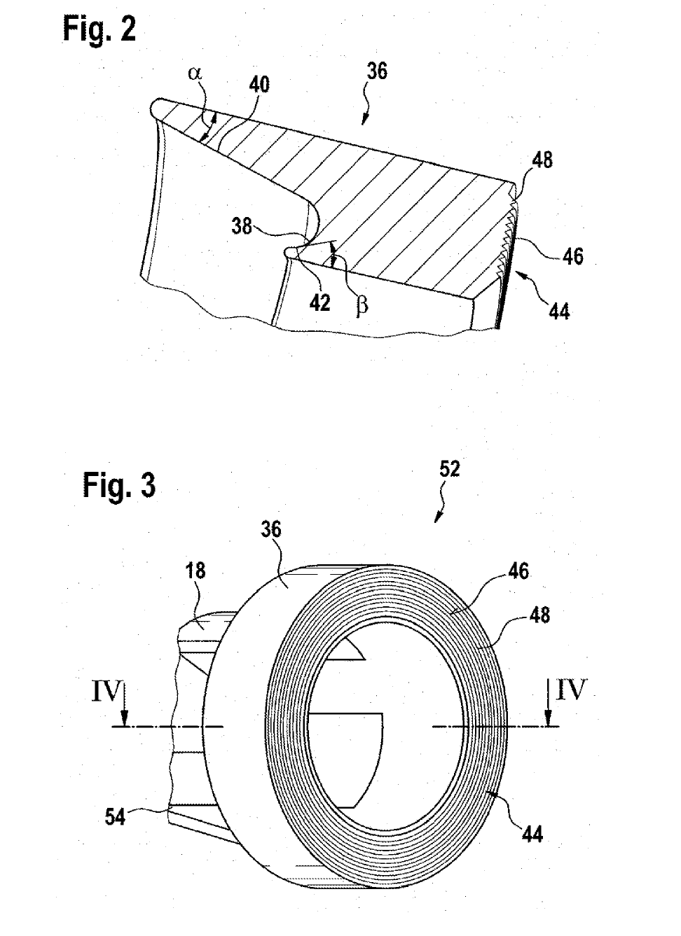

On the side facing the pressurized region 24 the seal element 36 (cf. also FIG. 2) comprises a high pressure-side sealing lip 38 having two limbs 40, 42, which in each case enclose a specific angle α,β, firstly with the inner circumferential surface of the cylinder 12 and secondly with the outer circumferential surface of the piston 14. A part of the valve housing 18 engages in and supports this high pressure-side sealing lip 38. The seal element 36 therefore bears radially inwards against the inner circumferential surface of the cylinder 12, so as to slide along this during the reciprocating movements of the piston 14 and in so doing to seal it off.

FIG. 2 shows the annular seal element 36 according to FIG. 1 in an enlarged representation. An end face 44 having a low pressure-side sealing contour 46 is arranged on the opposite side to the high pressure-side sealing lip 38. This sealing contour 46 comprises an arrangement of some, in particular eight, sealing lips 48, which in cross section taper to a point. With their tips the sealing lips 48 bear against a contact surface of the piston 14 (cf. FIG. 1). If pressure is exerted on the end face 44 of the seal element 36—when the piston 14 is run out by the return spring or when the piston 14 is run into the cylinder 12 by the eccentric drive—the sealing contour 46 is elastically deformed against the contact surface 50 of the piston 14. The sealing lips 48 tapering to a point incline to the side, attach themselves to the contact surface 50 and in this way seal off a region between the outer circumferential surface of the piston 15 and the inner circumferential surface of the cylinder 12, so that said region is substantially fluid-tight.

FIGS. 3, 4 and 5 show an annular seal element 36, which is formed together with a valve housing 18 as one integral component 52. Here this integral component 52 takes the form of a plastic injection-molded part, which is particularly inexpensive to manufacture. The valve housing 18 of the component 52 comprises four webs 54, which internally receive and guide the closing body 28 of the inlet valve 16. The webs 54 are furthermore frictionally braced with the mount 20 of the piston 14 (cf. FIG. 1).

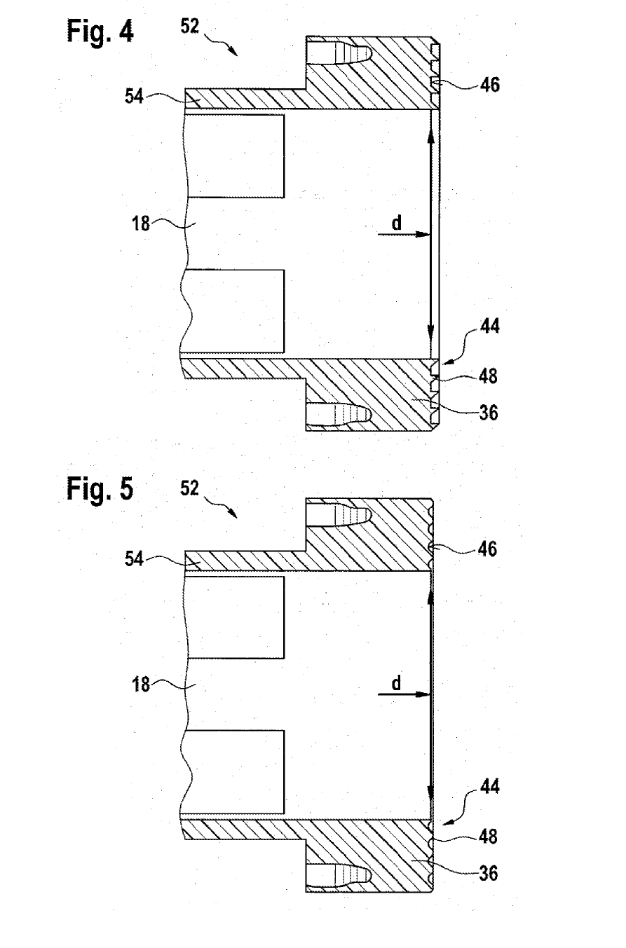

The seal element 36 of the component 52 comprises a sealing contour 46 having a plurality, in particular eleven, elastically deformable sealing lips 48 arranged in a circle. In FIGS. 3 and 4 the sealing lips 48, viewed in cross section, taper to a point, whereas the sealing lips 48 in FIG. 5 are of corrugated design in cross section.

Under the effect of pressure p the sealing lips 48, whether tapering to a point or corrugated, are pressed against the contact surface 50 of the piston 14 and are elastically deformed.

As is schematically represented in FIGS. 4 and 5, a pressure is firstly exerted perpendicularly to the end face 44 of the seal element 36, namely by the spring force of the return spring 32, as the piston 14 runs out of the cylinder 12, or by the eccentric drive as the piston 14 runs into the cylinder 12 (cf. also FIG. 1). As a result, the end face 44 of the seal element 36 is pressed onto the contact surface 50 of the piston 14 and the sealing lips 48 of the sealing contour 46 are correspondingly deformed.

Secondly, the fluid in the pressurized region 24 also exerts a pressure parallel to the end face 44, that is to say perpendicularly to the protruding sealing lips 48. These thereby attach themselves, according to this pressure direction of the fluid, to the contact surface 50 and seal off the contact surface 50 so that it is fluid-tight.

1. An annular seal element for sealing off a pressurized region filled with a fluid comprising:
an end face configured to press against a contact surface of a piston; and
a sealing contour formed on the end face such that the sealing contour is elastically deformable against the contact surface under an exerted pressure.

2. The annular seal element as claimed in claim 1, wherein the sealing contour comprises at least one sealing lip.

3. The annular seal element as claimed in claim 1, wherein the sealing contour comprises a plurality of sealing lips having a corrugated cross section.

4. The annular seal element as claimed in claim 1, wherein the sealing contour comprises a plurality of sealing lips having a cross section that tapers to a point.

5. The annular seal element as claimed in claim 1, wherein a plan view of the sealing contour is of has a helical configuration.

6. The annular seal element as claimed in claim 1, further comprising at least one, high pressure-side sealing lip integrally formed onto the annular seal element on a side arranged remotely from the end face.

7. The annular seal element as claimed in claim 1, wherein the annular seal element is a plastic injection-molded part.

8. The annular seal element as claimed in claim 1, wherein the annular seal element is integrally formed onto a valve housing.

9. A hydraulic piston pump comprising:
an annular seal element comprising:
an end face configured to press against a contact surface of a piston; and
a sealing contour formed on the end face such that the sealing contour is elastically deformable against the contact surface under an exerted pressure.

10. A vehicle braking system comprising:
a hydraulic piston pump comprising:
an annular seal element comprising:
an end face configured to press against a contact surface of a piston; and
a sealing contour formed on the end face such that the sealing contour is elastically deformable against the contact surface under an exerted pressure.
